(19) United States
(12) Patent Application Publication
(10) Pub. No.: US 2008/0215548 A1
(43) Pub. Date: Sep. 4, 2008

(54) INFORMATION SEARCH METHOD AND SYSTEM

(76) Inventors: Yosuke Ohashi, Saitama (JP); Yousuke Shirahata, Kanagawa (JP)

Correspondence Address: BIRCH STEWART KOLASCH & BIRCH, PO BOX 747, FALLS CHURCH, VA, 22040-0747, US

(21) Appl. No.: 12/027,047

(22) Filed: Feb. 6, 2008

(30) Foreign Application Priority Data
Feb. 7, 2007 (JP) 2007-028177

(51) Int. Cl. G06F 7/06

(52) U.S. Cl. 707/3; 707/E17.014

(57) ABSTRACT

An information search system for search in plural images as content information is provided. An input interface inputs a first image. An dominant color extractor extracts an dominant color as attribute of the first image. A tag extractor extracts a tag or descriptor as meta information associated with the dominant color. A retriever retrieves a second image having the extracted tag or descriptor among the plural images. Furthermore, a display panel displays the second image. Also, a search refining selector selects image among plural sets of the second image to be output according to degree of relevancy of the second image with the first image. The relevancy for evaluation is relevancy of the dominant color.

### BACKGROUND OF THE INVENTION

1. Field of the Invention

The present invention relates to an information search method and system. More particularly, the present invention relates to an information search method and system in which desired content information, for example an image, can be searched and selected from registered sets of content information with ease in a simplified process.

2. Description Related to the Prior Art

Mobile telephones and personal computers are widely used as electronic terminal device for transmitting and receiving information. Content information of various types can be retrieved and used in a very large scale with great ease, the content information including the image, motion picture of video image sequence, music, game, electronic book or the like. There is a new system in which many users only in connection with the network is enabled freely to register and retrieve content information, so as to share the collected information with one another, for example Web2.0, Flickr as an image sharing service of user participation. Also, free encyclopedia on the network is known, for example, Hatena Bookmark and Wikipedia.

In any of those information search systems, a tag as meta information is imparted to content information in order to search and retrieve desired content information efficiently among a great number of sets of stored content information. Such a method is called folksonomy. A tag is a word for representing a feature of the content information. For example, Coral Reef, Sea, Sky and the like are given as tags if the content information is an image of a coral reef, sea and sky of a southern island.

Various techniques are suggested for high efficiency and simplicity in registering and searching content information. JP-A 2-187864 discloses a method in which a physical characteristic, for example, color and frequency component, is extracted from the entirety or a portion of an image as content information. A tag is obtained by conversion of the physical characteristic. For example, if the result of the conversion of the color is R=1, G=0 and B=0, then the color is found red. If the frequency component is 0 for the entire image, 0 for an upper region and 0 for a left region, then a portion of low frequency is found large. A conversion data table is prepared for conversion into keywords such as Mountain and Sea. If the physical characteristic is Blue and Large portion of the low frequency, conversion with the conversion data table is made for keywords Sky and Sea, which are tags.

U.S. Pat. No. 5,945,982 (corresponding to JP-A 8-329096) discloses creating of a map which is based on axes of two or more dimensions as parameters, and in which a meaning of an image as content information or meta information of an image (tag, icon, comment of color balance or sound) is correlated with the parameters which are attributes of antonyms (for example, Modern and Traditional, Occidental and Oriental, and the like). Images and meta information are disposed in the map. A distance in the space of the map is designated for the degree of ambiguity in the course of search. Ambiguity search is possible according to automatic retrieval of images within a region defined about a query image.

U.S. Pat. No. 6,493,705 (corresponding to JP-A 2000-112956) discloses a keyword dictionary, which is looked up for retrieving a keyword related to a query word. Images are searched as content information according to the keywords and the query word. Also, a table data for combinations of imagination words and perception patterns is referred to, in order to retrieve a perception pattern according to the query word and keyword. A feature value of the retrieved perception pattern is used to search images. According to those two processes, search results are combined for generating an output. Let a phrase Fine Day be a query. Images suitable for the query can be searched and retrieved with high precision.

The system of folksonomy is publicly open to everybody, unlike a system in which only a system manager can register content information. The folksonomy is advantageous in possibility of unlimited enlargement of correlation between sets of content information. However, a shortcoming of JP-A 2-187864 lies in requirement of conversion data table for converting physical characteristics into keywords. An entire group of keywords is limited in view of future development.

In U.S. Pat. No. 5,945,982 (corresponding to JP-A 8-329096), a problem lies in that a process of creating a map is very complicated to require much time, and that only a closed space is available for the user creating the map. Also, a problem of U.S. Pat. No. 6,493,705 (corresponding to JP-A 2000-112956) lies in that relation data is required for association of a keyword dictionary, image keywords, and sensing patters. A system of the folksonomy is not utilized very much due to the cost for the preparation of the predetermined relation data.

### SUMMARY OF THE INVENTION

In view of the foregoing problems, an object of the present invention is to provide an information search method and system in which desired content information, for example an image, can be searched and selected from registered sets of content information with ease in a simplified process.

In order to achieve the above and other objects and advantages of this invention, an information search method includes a step of inputting first content information. An attribute of the first content information is extracted. Meta information associated with the attribute is extracted. Second content information having the extracted meta information is retrieved by accessing database with which the attribute, the meta information and the second content information are stored in association with one another. The second content information being retrieved is displayed.

Furthermore, there is a step of selecting, if plural sets of the second content information are retrieved, at least one set of the second content information to be displayed among the plural sets.

In the selecting step, the at least one set is selected among the plural sets to he output according to degree of relevancy of the second content information with the first content information.

The selecting step includes obtaining a score value for expressing the degree of the relevancy. Content information of which the score value is high is selected among the plural sets of the second content information.

The meta information is a descriptor assigned to respectively the first and second content information.

The relevancy for evaluation is relevancy of the attribute.

In one preferred embodiment, the relevancy for evaluation is relevancy of the meta information.

Preferably, the first and second content information is an image.

In a preferred embodiment, the attribute is a color of the image.

Data storage stores the attribute and the meta information associated therewith.

The plural sets of the content information and the meta information are stored in a data table, and the attribute and the meta information are stored in a data table.

In one preferred embodiment, an information search method of search in plural sets of content information is provided, and includes an inputting step of inputting first content information. In a meta information extracting step, meta information assigned to the first content information is extracted. In an attribute extracting step, an attribute of the first content information is extracted according to the meta information being extracted. In a retrieving step, second content information having the extracted attribute among the plural sets of the content information is retrieved.

Also, an information search system for search in plural sets of content information includes an input interface for inputting first content information. An attribute extractor extracts an attribute of the first content information. A meta information extractor extracts meta information associated with the attribute. A retriever retrieves second content information having the extracted meta information among the plural sets of the content information.

Furthermore, a display panel displays the second content information.

Furthermore, a search refining selector selects content information among plural sets of the second content information to be output according to degree of relevancy of the second content information with the first content information.

Furthermore, first data storage stores the plural sets of the content information and the meta information assigned thereto. Second data storage stores the attribute and the meta information associated therewith.

In a preferred embodiment, an information search system for search in plural sets of content information includes an input interface for inputting first content information. A meta information extractor extracts meta information assigned to the first content information. An attribute extractor extracts an attribute of the first content information according to the meta information being extracted. A retriever retrieves second content information having the extracted attribute among the plural sets of the content information.

Also, a computer executable program for information search in plural sets of content information is provided, and includes an inputting program code for inputting first content information. An attribute extracting program code is for extracting an attribute of the first content information. A meta information extracting program code is for extracting meta information associated with the attribute. A retrieving program code is for retrieving second content information having the extracted meta information among the plural sets of the content information.

In addition, a user interface for information search in plural sets of content information is provided, and includes an inputting region for inputting first content information. An attribute extracting region is for extracting an attribute of the first content information. A meta information extracting region is for extracting meta information associated with the attribute. A retrieving region is for retrieving second content information having the extracted meta information among the plural sets of the content information.

Consequently, desired content information, for example an image, can be searched and selected from registered sets of content information with ease in a simplified process in an information search method and system of the invention, because the attribute and meta information are utilized in combination.

### BRIEF DESCRIPTION OF THE DRAWINGS

The above objects and advantages of the present invention will become more apparent from the following detailed description when read in connection with the accompanying drawings, in which:

FIG. 1 is a block diagram schematically illustrating the image search system;

FIG. 2 is a block diagram schematically illustrating circuit elements in a personal computer for the image search;

FIG. 3 is a block diagram schematically illustrating circuit elements in a management server for the image search;

FIG. 4 is a table illustrating data in an image data table;

FIG. 5 is a table illustrating data in a dominant color/tag data table;

FIG. 6 is a front elevation illustrating a search window;

FIG. 7 is a flow chart illustrating an image search;

FIG. 8 is a flow chart illustrating a portion of another preferred image search of the invention.

### DETAILED DESCRIPTION OF THE PREFERRED EMBODIMENT(S) OF THE PRESENT INVENTION

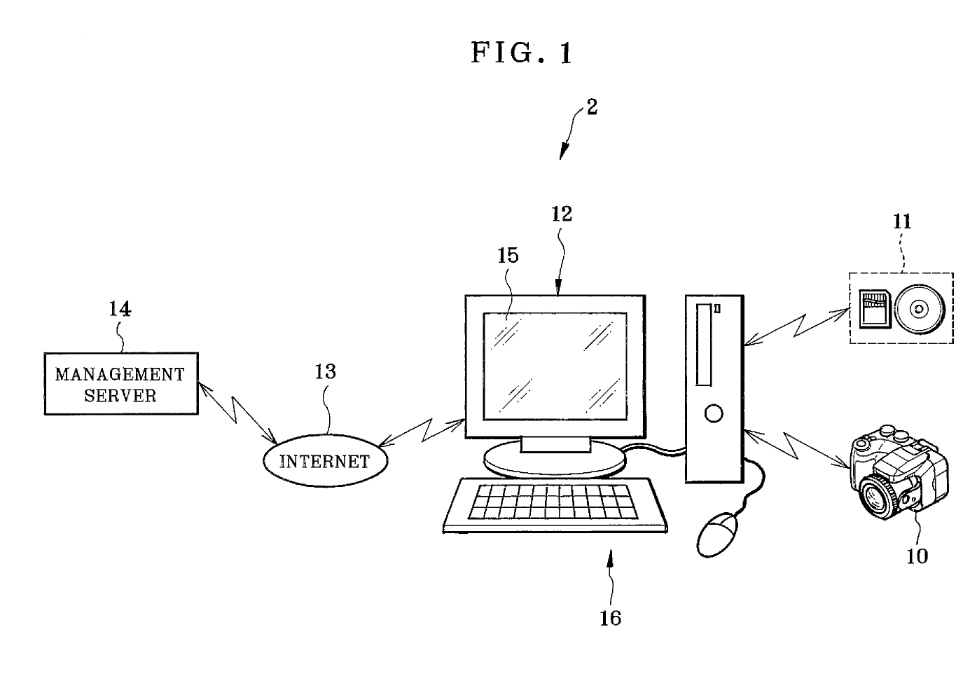

In FIG. 1, an image search system 2 for registration and search of images includes a personal computer 12 and a management server 14. A digital still camera 10 of a user photographs images to obtain image data. Also, data storage 11, such as a memory card or CD-R, stores image data of electronic image, such as digitized in the TIFF or JPEC format. The personal computer 12 retrieves the image data from the digital still camera 10 or the data storage 11. The personal computer 12 accesses the management server 14 by means of the Internet 13 as network, to register and/or search images in the database.

The digital still camera 10 is connected to the personal computer 12 by any of various connecting interfaces, such as IEEE 1394, USB (Universal Serial Bus), and other communication cables, and wireless LAN (local area network). Data can be transmitted and received between the digital still camera 10 and the personal computer 12. Also, the data storage 11 is accessed by use of a driver for reading and writing data in connection with the personal computer 12.

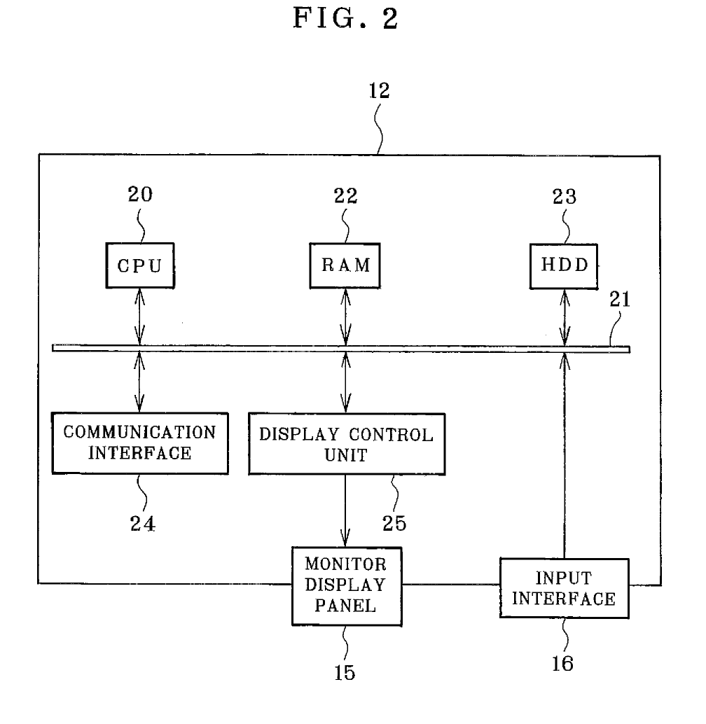

A user interface of the personal computer 12 includes a monitor display panel 15 and an input interface 16, which has a keyboard and a mouse. In FIG. 2, a CPU 20 controls various circuit elements of the personal computer 12. In addition to the input interface 16, elements are connected with the CPU 20 by a data bus 21, including a RAM 22, a hard disk drive 23, a communication interface 24 and a display control unit 25.

The hard disk drive (HDD) 23 stores programs and data for operating the personal computer 12, a viewer program as software for registering and searching images, and a plurality of image data retrieved from the digital still camera 10 or the data storage 11. The CPU 20 reads the programs from the hard disk drive 23, and executes the programs by use of the RAM 22. The CPU 20 operates elements of the personal computer 12 in response to an input signal generated by the input interface 16.

The communication interface 24 transmits and receives data between an external device such as the digital still camera 10 and the Internet 13 or other network. The display control unit 25 controls the monitor display panel 15 to display an image of windows of a screen or the like in relation to the viewer program.

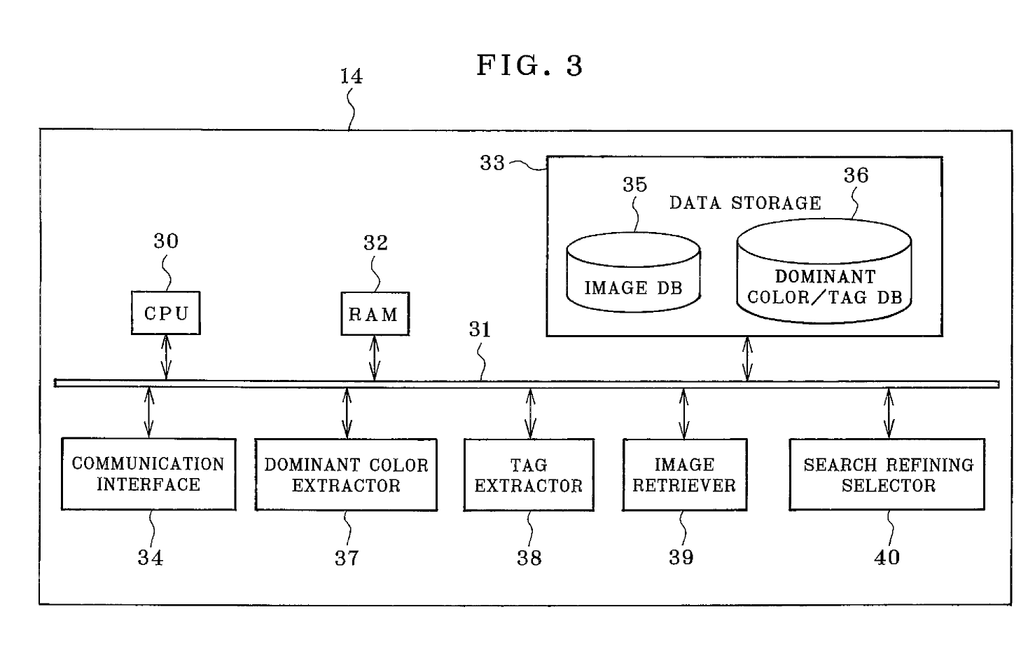

In FIG. 3, a CPU 30 controls various circuit elements of the management server 14. A RAM 32, data storage 33 and a communication interface 34 are connected by a data bus 31 to the CPU 30.

The data storage 33 stores programs and data for running the management server 14. The CPU 30 reads the programs from the data storage 33, and executes the programs one after another by use of the RAM 32 as a memory for writing. The communication interface 34 transmits and receives data with the Internet 13 as communication network.

The data storage 33 has regions of an image database 35 and a dominant color/tag database 36. The image database (DB) 35 stores image data of images registered by the personal computer 12.

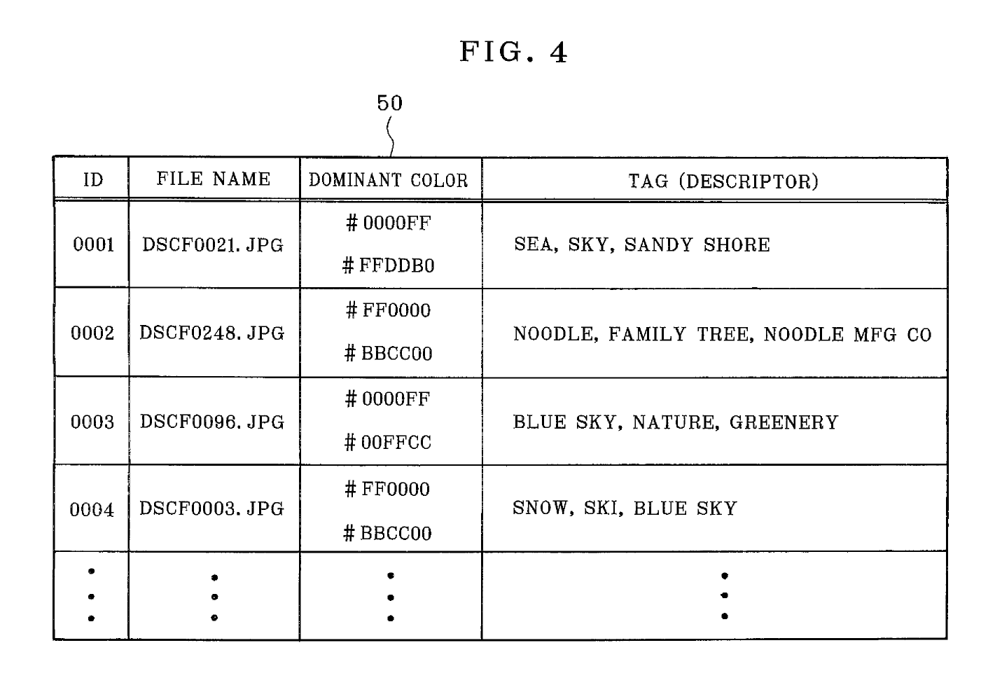

In FIG. 4, an image data table 50 is stored in the image database 35. Specifically, the image data table 50 is a table of image data of registered images, file names of the image data, dominant colors of the images, and tags of the images as descriptors or index terms included in meta information. The number of the dominant colors is n for each one registered image, although only two dominant colors are illustrated. A term of registered images is used to mean the stored images in the image database 35. New registered images mean images stored newly in the image database 35.

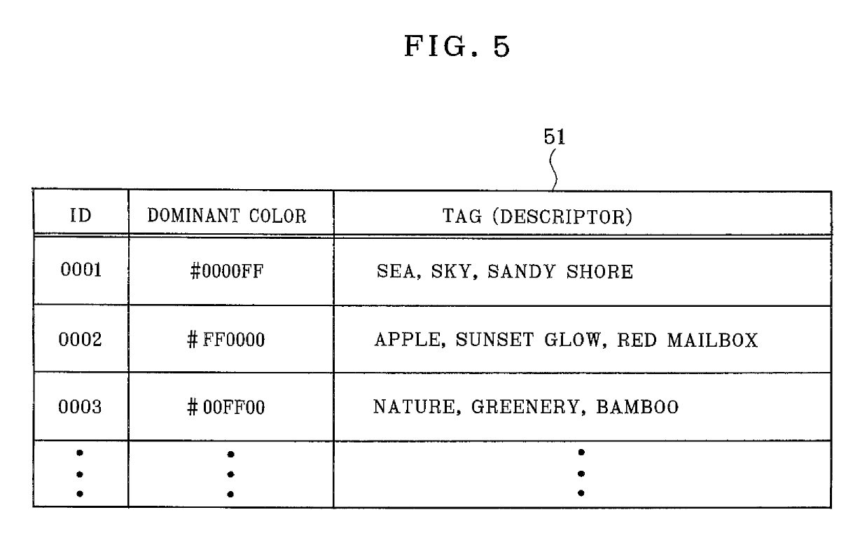

In FIG. 5, a dominant color/tag data table 51 is stored in the dominant color/tag database (DB) 36, in which a dominant color and a tag assigned with the dominant color are combined by use of equal ID data. For example, a dominant color is blue. Tags for the blue are Sea, Sky, Sandy Shore and the like. The dominant color/tag data table 51 is created by combining a dominant color with an extracted tag, the dominant color being referred to in the image data table 50 and classified by the ID data. Each time that new registered image data of one image is stored, a new tag of the new registered image data is added to the dominant color/tag data table 51 for renewal. (If a tag equal to that of the new registered image data has been already stored for the same dominant color, there is no renewal.) To each one of the dominant color, plural tags maybe assigned, or only one tag may be assigned. If there are two dominant colors of red and green, tags for those can be Christmas and Autumn Leaves. It is possible that plural dominant colors are associated with one tag or plural tags.

In FIG. 3, a dominant color extractor 37 as attribute extractor analyzes new registered image data from the personal computer 12, and extracts dominant colors of the image data of the images. An image data analysis of a specific method is as follows. The dominant color extractor 37 creates a histogram in which a gradation value of a color of a pixel to constitute new registered images is taken on the horizontal axis, and the number of times of occurrence of a gradation value in all of the pixels is taken on the vertical axis. A dominant color is obtained as a color represented by the gradation value of which a rank of the number of times of occurrence is Nos. 1-n. In a manner similar to the new registered image data, the dominant color extractor 37 extracts a dominant color for an input image data of an input image as a search query in the course of the retrieval. The dominant color extractor 37 supplies the CPU 30 with data of extracted n dominant colors. In the embodiment, the gradation value is R, C and B data of 8 bits of #00-# FF (expressed hexadecimally). A color of a pixel is expressed, for example, as #000000 in an order of R, G and B in the hexadecimal notation. See FIGS. 4 and 5. A dominant color of #0000FF in FIG. 4 is a blue color. A dominant color of # FF0000 is a red color.

A tag extractor 38 as meta information extractor reads data of a dominant color according to the dominant color extractor 37 for an input image from the CPU 30, and reads the dominant color/tag data table 51 from the dominant color/tag database 36. The tag extractor 38 extracts a tag from the dominant color/tag data table 51, the tag being descriptor or meta information assigned with a dominant color which coincides with or is similar to at least one of n dominant colors of an input image from the dominant color extractor 37.

A dominant color similar to the dominant color output by the dominant color extractor 37 is a color of which a distance in the three dimensional color space of R. G and B is smaller than a predetermined threshold distance, namely color in a region of a sphere which is defined about the dominant color output by the dominant color extractor 37 with a radius of the threshold distance. The tag extractor 38 sends the data of the extracted tag to the CPU 30.

An image retriever 39 reads data of the tag extracted from the tag extractor 38 from the CPU 30, and reads the image data table 50 from the image database 35. The image retriever 39 retrieves a registered image from the image database 35 by search according to association with at least one of tags obtained by the tag extractor 38 by referring to the image data table 50. The image retriever 39 sends the retrieved image data to the CPU 30.

A search refining selector 40 reads registered image data from the CPU 30 according to images retrieved by the image retriever 39. Score values of the registered images being read are determined. Selected images among the registered images are designated according to the score values as results of the retrieval from the input image. Note that the score value is a value for the degree of relation of the retrieved registered images with the input image, namely, degree of suitability of the retrieved registered images as output images.

To calculate the score value is based on the degree of coincidence between a tag assigned to the registered image retrieved by the image retriever 39 and a tag obtained by the tag extractor 38. For example, the number of tags of the coincidence is counted, and is added to the score value. In addition to this, or instead of this, calculation of the score value is based on the degree of coincidence or degree of similarity between the dominant color of the registered image retrieved by the image retriever 39 and the dominant color of the input image. Let +1 point be given for the coincidence. Let +0.5 point be given for the similarity. If five (5) tags coincide and two (2) tags are similar, the score value is 5+(0.5×2)=6 points. Note that the dominant color of the retrieved registered image may be that stored in the image data table 50, and also can be the dominant color obtained by repeated extraction of the dominant color in the dominant color extractor 37 for the retrieved registered image. The score value being determined is higher for the registered image with tags of the degree of the coincidence with the tag extracted by the tag extractor 38 according to the input image, and also is higher for the registered image with the dominant color of the coincidence or similarity with the dominant color of the input image.

The search refining selector 40 selects registered images of which a rank of highness of the score value is any one of Nos. 1-m, or registered images of which the score value is higher than a reference score value. Selected registered images are output images. The search refining selector 40 sends output image data of the output image to the CPU 30. The CPU 30 sends the output image data from the search refining selector 40 to the personal computer 12 by means of the communication interface 34.

The CPU 30 writes new registered image data or input image data to the image database 35, and adds ID data to the data. A file name of the data, the dominant color output by the dominant color extractor 37 and a tag input by a user are combined and written in the image data table 50. Note that a tag extracted by the tag extractor 38 can be stored in addition to the manually input tag at the time of storing input image data.

To register or search images, a viewer program is started up by operating the input interface 16. At first, a status of the user is verified to check authorization of access to the management server 14. After this, the access is allowed for the registration and search.

In the viewer program, operation modes are selectable, and include an image registration mode and a search mode. To register an image, thumbnail images of images stored in the hard disk drive 23 are displayed on the monitor display panel 15 in a listed form. A selected one of the thumbnail images of a new registered image is designated by operating the input interface 16. At the same time, a suitable tag for the new registered image is input by the input interface 16.

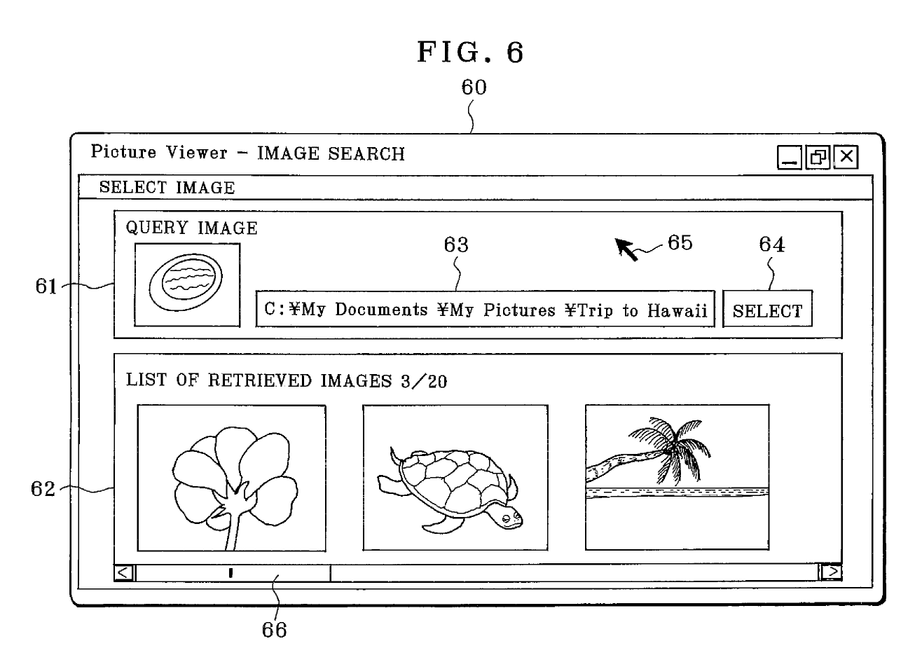

When the image search mode is set, a search window 60 of FIG. 6 is displayed on the monitor display panel 15. Two regions appear in the search window 60, including an inputting region 61 with an image as first content information, and an output image region 62 or retrieving region with images as second content information.

Regions of a file dialog 63 and a selection button 64 are contained in the inputting region 61. The file dialog 63 indicates a thumbnail form of an input image, and a path of a storage area in the hard disk drive 23 for the input image. The selection button 64 is for selection of an input image. A pointer 65 is set and clicked at the selection button 64 by operating a mouse of the input interface 16. Then the file dialog 63 is enlarged, and comes to display a list of icons for files and folders stored in the hard disk drive 23 in plural directories. The mouse of the input interface 16 can be operated to select any of input images by clicking the pointer 65 at an icon of a file of an image according to preference.

Before selecting an input image, the output image region 62 or retrieving region does not appear itself, or does not display an image. After an input image is selected, the management server 14 selects output images as described above. When output image data are received from the management server 14 by means of the communication interface 24, thumbnail images are displayed in the output image region 62. A sequence of displaying output images is not limited, but can be according to the highness of their score value determined by the search refining selector 40, or the date of the registration. A scroll bar 66 disposed under the output image region 62 is a button for scrolling a group of thumbnail images in a limited area of the screen.

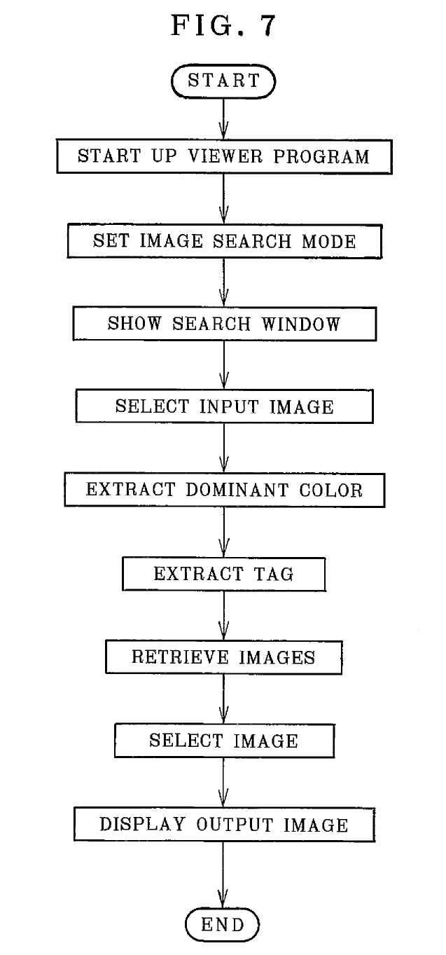

A processing sequence of the image search system 2 constructed above is described by referring to FIG. 7. At first, a viewer program is started up. The search mode for images is set, to display the search window 60 on the monitor display panel 15. A user selects the selection button 64 by use of the input interface 16, and selects an input image from the file dialog 63. Data of the selected input image are transmitted by the communication interface 24 and the Internet 13 to the management server 14.

The management server 14 has the communication interface 34 which receives the input image data. The input image data is supplied to the dominant color extractor 37. The dominant color extractor 37 extracts n dominant colors of the input image by the image data analysis of the input image data. Data of the n dominant colors are sent to the CPU 30.

After extracting the dominant color, the dominant color/tag data table 51 and data of the dominant color obtained by the dominant color extractor 37 are read from the dominant color/tag database 36 and the CPU 30 by the tag extractor 38. The tag extractor 38 retrieves a tag or descriptor from the dominant color/tag data table 51 in association with a color of coincidence or similarity with at least one of the n dominant colors obtained by the dominant color extractor 37. The data of the tag retrieved by the tag extractor 38 is output to the CPU 30.

After extracting the tag, the image data table 50 and data of the tag obtained by the tag extractor 38 are read from the image database 35 and the CPU 30 by the image retriever 39. The image retriever 39 refers to the image data table 50, and retrieves registered images from the image database 35 in association with at least one of tags obtained by the tag extractor 38. The registered image data retrieved by the image retriever 39 are output to the CPU 30.

After the image search, the registered image data retrieved by the image retriever 39 are read by the search refining selector 40 from the CPU 30. The search refining selector 40 determines a score value of registered images read from the CPU 30 according to degree of coincidence of a tag of the registered image retrieved by the image retriever 39 and a tag obtained by the tag extractor 38, or according to degree of coincidence or similarity of a dominant color of the retrieved registered image and a dominant color of an input image. Registered images of which a rank of highness of the score value is any one of Nos. 1-m are selected, or registered images of which the score value is higher than a reference score value are selected. The selected registered images are output images. Output image data selected by the search refining selector 40 is sent to the CPU 30.

The output image data in the CPU 30 is sent to the personal computer 12 by use of the communication interface 34. At the same time, input image data is written to the image database 35. A file name of the input image data is stored in the image data table 50 in association with the dominant color obtained by the dominant color extractor 37 and the tag input manually.

When the output images are received from the management server 14 by the personal computer 12 with the communication interface 24, thumbnail images of output images are displayed in the output image region 62 or retrieving region of the search window 60 in a listed form. The user views the image list, and can download a desired one of the output images.

If a registration mode is set, thumbnail images stored in the hard disk drive 23 are displayed on the monitor display panel 15. A user operates the input interface 16, selects a thumbnail image of a new registered image on the monitor display panel 15, adds a tag to the registered image, and transmits its image data to the management server 14. The dominant color extractor 37 in the management server 14 extracts a dominant color of new registered image data. Also, the CPU 30 writes the new registered image data to the image database 35. At the same time, a file name of the new registered image data, a dominant color output by the dominant color extractor 37, and a tag input manually by a user are stored in the image data table 50. Also, a tag of the new registered image is additionally assigned to a relevant dominant color in the dominant color/tag data table 51, to renew the dominant color/tag data table 51.

As described heretofore, a tag is extracted from the dominant color/tag database 36 according to a dominant color of an input image as search query. A registered image according to the tag is retrieved from the image database 35, to determine and display an output image. Thus, no specific dictionary for conversion is necessary. It is unnecessary for a user to prepare reference data initially. Also, the construction of the invention is advantageous for its very low cost. Tags of various types in a large region are utilized in a general-purpose manner covering expectation of numerous users of different types. So the image search can be smoothly effected because of a vast range of many results of search. This is effective in increasing the number of future users of the image search system 2. Variety of the search results can become still wider.

Also, it is possible to eliminate unrelated registered images from output images in view of input images, because the output images are selected according to the score value of relevancy of registered images retrieved by the image retriever 39 as output images. Thus, properly selected output images can be displayed.

Also, it is possible in the search window 60 to indicate information of any one of the extracted dominant color and extracted tag, or both of those for the purpose of clarity.

In the embodiment, an input image is a new registered image without association of a dominant color. However, an input image may be one of the registered images. Data of the dominant color is predetermined for the registered image. It is unnecessary in the dominant color extractor 37 to extract a dominant color. It is to be noted that a dominant color may be extracted for a second time, and can be used for a subsequent task.

In the above embodiment, a dominant color of an input image is extracted by the dominant color extractor 37 before a tag assigned to the dominant color is extracted by the tag extractor 38. However, it is possible to extract a tag with the tag extractor 38 at first, and then to extract a dominant color associated with the extracted tag.

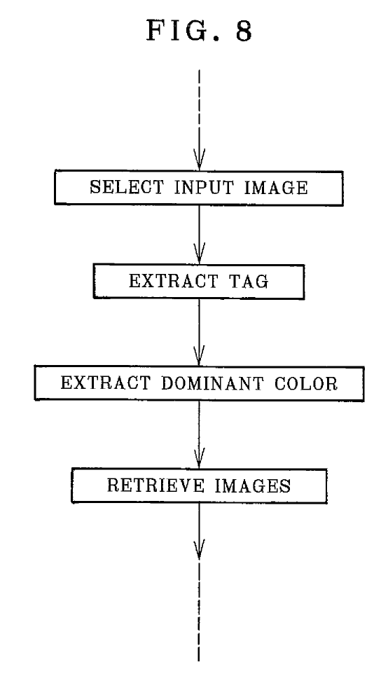

In FIG. 8, a flow of a preferred embodiment is illustrated. Initial steps and final steps indicated by the broken lines are the same as those in the FIG. 7. At first, the tag extractor 38 extracts a tag or descriptor as meta information associated with an input image. The dominant color extractor 37 extracts a dominant color from the dominant color/tag database 36 in association with the tag obtained by the tag extractor 38.

After extracting the dominant color, the image retriever 39 searches registered images in the image database 35 which have dominant colors at least one of which coincides with that extracted by the dominant color extractor 37. The search refining selector 40 calculates and obtains a score value according to degree of coincidence of a dominant color of images from the image retriever 39 with a dominant color obtained by the dominant color extractor 37, or the degree of similarity between those, or the degree of coincidence of a tag associated with images from the image retriever 39 with a tag associated with an input image.

In a manner similar to the above, the search refining selector 40 selects registered images of which a rank of highness of the score value is any one of Nos. 1-m, or registered images of which the score value is higher than a reference score value. Selected registered images are output images. As a result, effects similar to those of the above embodiment can be obtained. Note that the dominant color extractor 37 extracts a new registered image and a dominant color of an input image by the image data analysis creating a histogram or the like at the time of registering an image and writing the input image to the image database 35. It is possible to write the dominant color from the dominant color extractor 37 in the image data table 50 according to the tag from the tag extractor 38, in place of, or in addition to, the dominant color extracted by the image data analysis with the histogram at the time of writing the input image to the image database 35.

The details of the above embodiment are only examples, in relation to the method of extracting a dominant color, image search method, determination of a score value, selection of output images, appearance of the search window 60 for display. The invention is not limited to the embodiments.

In the embodiments, the attribute of images is a dominant color. However, an attribute of an image may be a form of an object in an image, a size of an object, brightness, sharpness, contrast or the like of the image. Furthermore, two or more attributes can be combined for use in extraction of a tag or retrieval of an image.

In the above embodiment, images are registered or searched by use of the viewer program. However, it is possible on a web page of the Internet to register or search images. In the embodiment, the dominant color extractor 37 and other elements are included in the management server 14. However, those can be separate devices, which can be connected externally to the personal computer 12. Furthermore, elements of the management server 14 such as the image database 35 may be incorporated in the personal computer 12. Any suitable modifications of the construction are possible in the invention.

Examples of meta information can be information of a text format, information of sound or voice, or the like in place or the tag or descriptor of the above embodiments. Content information is images in the embodiments. However, content information of the invention may be motion picture of a video image sequence, music, game, electronic book or the like. If the content information is an electronic book or other text information, examples of attribute to be extracted are a type of the document, style or the like of the text. The attribute can be obtained by vocabulary analysis of analyzing distribution of terms in a text as vocabulary, syntax analysis of grammatical structure of the text, analysis of elements in which the text is split into smallest elements which have meanings in the language, for classification into parts of speech. If the content information is sound or voice, the information is analyzed by frequency analysis or the like, to extract attribute, which can be the pitch of the sound, type of the music, and the like. The search of the invention may be used for searching articles registered in an auction web page in the Internet.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An information search method comprising steps of:
inputting first content information;
extracting an attribute of said first content information;
extracting meta information associated with said attribute;
retrieving second content information having said extracted meta information by accessing database with which said attribute, said meta information and said second content information are stored in association with one another;
displaying said second content information being retrieved.

2. An information search method as defined in claim 1, further comprising a step of selecting, if plural sets of said second content information are retrieved, at least one set of said second content information to be displayed among said plural sets.

3. An information search method as defined in claim 2, wherein in said selecting step, said at least one set is selected among said plural sets to be output according to degree of relevancy of said second content information with said first content information.

4. An information search method as defined in claim 3, wherein said selecting step includes:
obtaining a score value for expressing said degree of said relevancy; and
selecting content information of which said score value is high among said plural sets of said second content information.

5. An information search method as defined in claim 3, wherein said relevancy is relevancy of said meta information between said first and second content information.

6. An information search method as defined in claim 3, wherein said relevancy is relevancy of said attribute between said first and second content information.

7. An information search method as defined in claim 2, wherein said first and second content information is an image.

8. An information search method as defined in claim 7, wherein said attribute is a color of said image.

9. An information search method as defined in claim 2, wherein data storage stores said attribute and said meta information associated therewith.

10. An information search method as defined in claim 2, wherein said plural sets of said second content information and said meta information are stored in a data table, and said attribute and said meta information are stored in a data table.

11. An information search method comprising steps of:
inputting first content information;
extracting meta information assigned to said first content information;
extracting an attribute of said first content information according to said meta information being extracted;
retrieving second content information having said extracted attribute by accessing database with which said attribute, said meta information and said second content information are stored in association with one another;
displaying at least one set of said second content information selectively among plural sets of said second content information being retrieved.

12. An information search method as defined in claim 11, wherein said meta information is a descriptor assigned to respectively said first and second content information.

13. An information search system comprising:
an input interface for inputting first content information;
an attribute extractor for extracting an attribute of said first content information;
a meta information extractor for extracting meta information associated with said attribute;
a retriever for retrieving second content information having said extracted meta information by accessing database with which said attribute, said meta information and said second content information are stored in association with one another;
a selector for selecting at least one set of said second content information among plural sets of said second content information being retrieved; and
a display panel for selectively displaying said second content information being retrieved.

14. An information search system as defined in claim 13, wherein said meta information is a descriptor assigned to respectively said first and second content information.

15. An information search system as defined in claim 13, wherein said selector selects content information among plural sets of said second content information to be output according to degree of relevancy of said second content information with said first content information.

16. An information search system as defined in claim 15, wherein said selector obtains a score value for expressing said degree of said relevancy, and selects content information of which said score value is high among said plural sets of said second content information.

17. An information search system as defined in claim 13, further comprising:
first data storage for storing said plural sets of said content information and said meta information assigned thereto; and
second data storage for storing said attribute and said meta information associated therewith.

18. An information search system comprising:
an input interface for inputting first content information;
a meta information extractor for extracting meta information assigned to said first content information;
an attribute extractor for extracting an attribute of said first content information according to said meta information being extracted;
a retriever for retrieving second content information having said extracted attribute by accessing database with which said attribute, said meta information and said second content information are stored in association with one another;
a display panel for selectively displaying plural sets of said second content information being retrieved.
